(19) United States
(12) Patent Application Publication
(10) Pub. No.: US 2003/0099173 A1
(43) Pub. Date: May 29, 2003

(54) Apparatus and method of compensating a phase error in a wobble PLL

(76) Inventor: Jung Bae Park, Kyunggi-do (KR)

Correspondence Address: BIRCH STEWART KOLASCH & BIRCH, PO BOX 747, FALLS CHURCH, VA, 22040-0747, US

(21) Appl. No.: 10/234,194

(22) Filed: Sep. 5, 2002

(30) Foreign Application Priority Data
Sep. 5, 2001 (KR) 01-54445

(51) Int. Cl. G11B 7/00

(52) U.S. Cl. 369/47.28; 369/53.34

(57) ABSTRACT

The present invention relates to apparatus and method of making fast phase synchronization of a clock used for data reading/writing with an input wobble signal detected from a writable recording medium such as a CD and a DVD. The present method checks continuously whether or not the wobble signal makes a transition from negative to positive level, reads a current count value of a clock generator, which generates the clock through a repetitive free-running count operation of an applied control signal, when the transition occurs, determines a range the read count value belongs to, and sets the count value to one of predetermined values (a countable maximum value, a half of the maximum value, and zero) forcibly wherein said one is chosen based on the determined range.

### BACKGROUND OF THE INVENTION

1. Field of the Invention

The present invention relates to apparatus and method of enabling fast phase synchronization of a clock used for data reading/writing with an input wobble signal detected from a writable recording medium such as a CD (Compact Disk) and a DVD (Digital Versatile Disk).

2. Description of the Related Art

FIG. 1 shows a block diagram of a conventional wobble PLL (Phase Locked Loop) and its peripheral elements. The wobble PLL (100) configured as FIG. 1 includes a phase-difference detector 12, a loop filter 13, and a DCO (Digital Controlled Oscillator) 14.

In front of the wobble PLL (100), two elements, a band-pass filter 10 and an A/D converter 11 are placed. The band-pass filter 10 filters out high-frequency noise, a DC offset component, and so on that might be included in a pure wobble signal detected from a recording medium, and the A/D converter 11 digitizes the pure wobble signal outputted from the band-pass filter 10.

The phase-difference detector 12 of the wobble PLL 100 binarizes the digitized wobble signal 201 to high or low level on a basis of a slice level to output a square-wave wobble signal 202 shown in FIG. 2. At the same time, it detects phase difference between the square-wave wobble signal 202 and a PLL clock 203 from the DCO 14, and applies the detected phase difference to the loop filter 13.

The loop filter 13 adjusts the PLL clock 203 of the DCO 14 based on the applied phase difference to synchronize the PLL clock 203 with the square-wave wobble signal 202 in phase.

FIG. 3 shows schematically a phase-synchronizing manner that is conducted as follows by the wobble PLL 100.

The phase-difference detector 12 detects positive or negative phase difference at every negative zero crossing point (NZCP) of the square-wave wobble signal 202. The positive phase difference, marked 301 in FIG. 3, means that the PLL clock 203 leads the wobble signal in phase while the negative, marked 302 in FIG. 3, means the opposite case. The detected phase difference is applied to the loop filter 13. Then, based on the phase difference, the loop filter 13 adjusts a range-setting voltage Vset applied to the DCO 14. The range-setting voltage Vset determines PLL clock speed of the DCO 14.

The DCO 14 conducts a free counting-down operation for an applied Vset repeatedly while outputting a pulse having 50% duty-ratio every reach to zero. The successive pulses from the DCO 14 constitutes the PLL clock 203.

Therefore, the loop filter 13 increases the range-setting voltage Vset for the case 301, then, the PLL clock is delayed in phase because range to count down becomes larger. On the contrary, the loop filter 13 decreases Vset as much as the negative difference for the case 302 to advance phase of the PLL clock.

Through the adjustment of the range-setting voltage, the PLL clock 203 becomes in phase with the wobble signal 201 or 202.

The bit detector 15 placed after the wobble PLL 100 converts the square-wave wobble signal 202 to successive bits composed of “1” or “0” using the synchronized PLL clock 203.

However, because the adjustment of PLL clock speed of the DCO 14 is conducted only when an NZCP is encountered, Vset is adjusted at a next NZCP after a phase-difference is detected at a previous NZCP. Therefore, instantaneous phase synchronization can not be achieved.

Furthermore, because the sliced wobble signal varies in duty ratio, an NZCP may be encountered later than an average transition point. In this case, correction of current phase difference would take longer time.

The delay in phase-difference correction and the variation in correction time cause deterioration of jitter characteristic.

### SUMMARY OF THE INVENTION

It is an object of the present invention to provide apparatus and method of compensating a phase gap between a PLL clock and an input wobble signal prior to or concurrently with a phase-synchronization in order to make the PLL clock be in phase with the wobble signal faster.

A method of compensating a phase gap between a clock and an input wobble signal in accordance with the present invention checks whether or not the wobble signal makes a transition from negative to positive level, reads a current count value of a clock generator, which generates the clock through a repetitive free-running count operation of an applied control signal, when the transition occurs, and sets the count value to one of predetermined values forcibly wherein said one is chosen based on which zone the read count value belongs to.

### BRIEF DESCRIPTION OF THE DRAWINGS

The accompanying drawings, which are included to provide a further understanding of the present invention, illustrate the preferred embodiments of the invention, and together with the description, serve to explain the principles of the present invention, and wherein:

FIG. 1 shows a block diagram of a conventional wobble PLL and its peripheral elements;

FIG. 2 shows actual waveforms of signals used/outputted in/from a conventional wobble PLL;

FIG. 3 shows schematically a phase-synchronizing manner that is conducted by a conventional wobble PLL;

FIG. 4 shows a block diagram of a wobble PLL configured according to the present invention and its peripheral elements;

FIG. 5 depicts a phase-gap compensating algorithm of the present invention; and

FIGS. 6 and 7 illustrate a lead and a lag case respectively where a phase gap between a PLL clock and an input wobble signal is compensated according to the present invention.

### DETAILED DESCRIPTION OF THE PREFFERRED EMBODIMENT

In order that the invention may be fully understood, a preferred embodiment thereof will now be described with reference to the accompanying drawings.

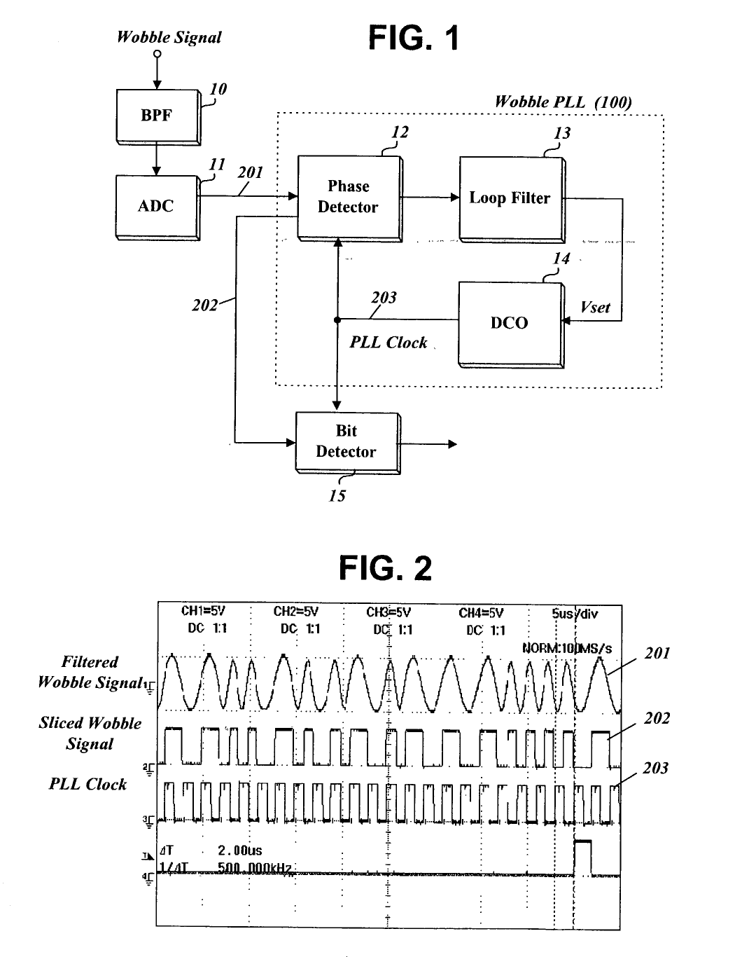

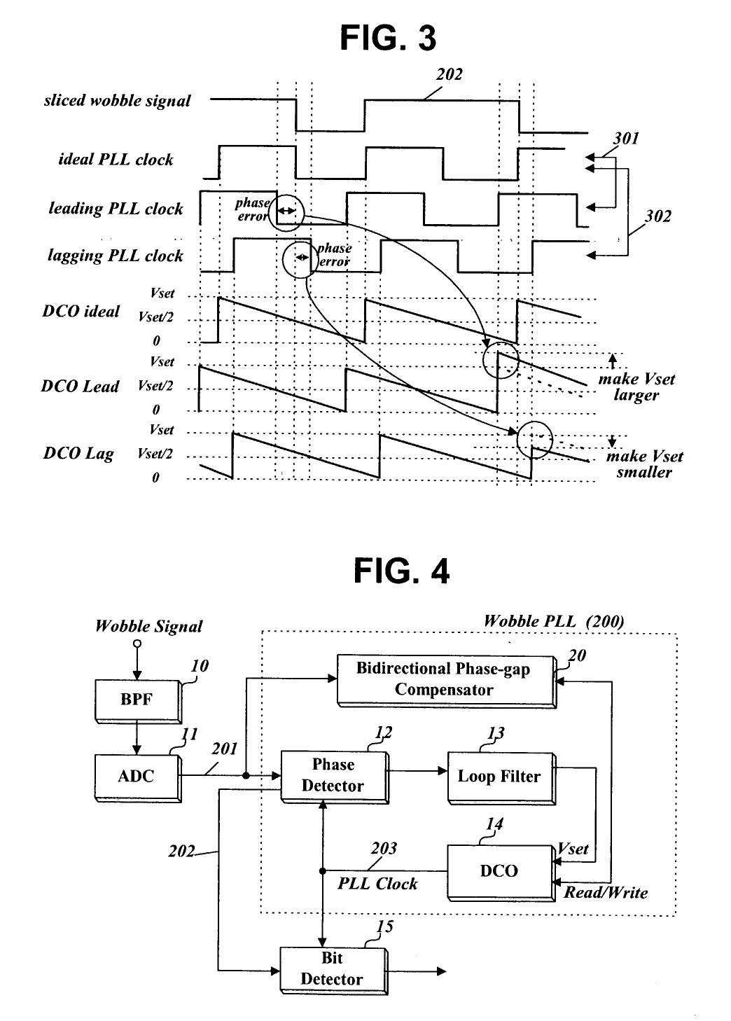

FIG. 4 shows a block diagram of a wobble PLL configured according to the present invention and its peripheral elements. The wobble PLL 200 structured in accordance with the present invention includes a bidirectional phase-gap compensator 20 for compensating a phase-gap instantaneously and the elements mentioned in FIG. 1 that are the phase difference detector 12, the loop filter 13, and the DCO 14.

The phase difference detector 12, the loop filter 13, and the DCO 14 that are included in the wobble PLL 200 conduct a phase-synchronizing operation as conventional art. Namely, they detects a phase difference at every NZCP, and adjust the Vset applied to the DCO 14 at a next NZCP to eliminate any phase difference between the PLL clock and the wobble signal.

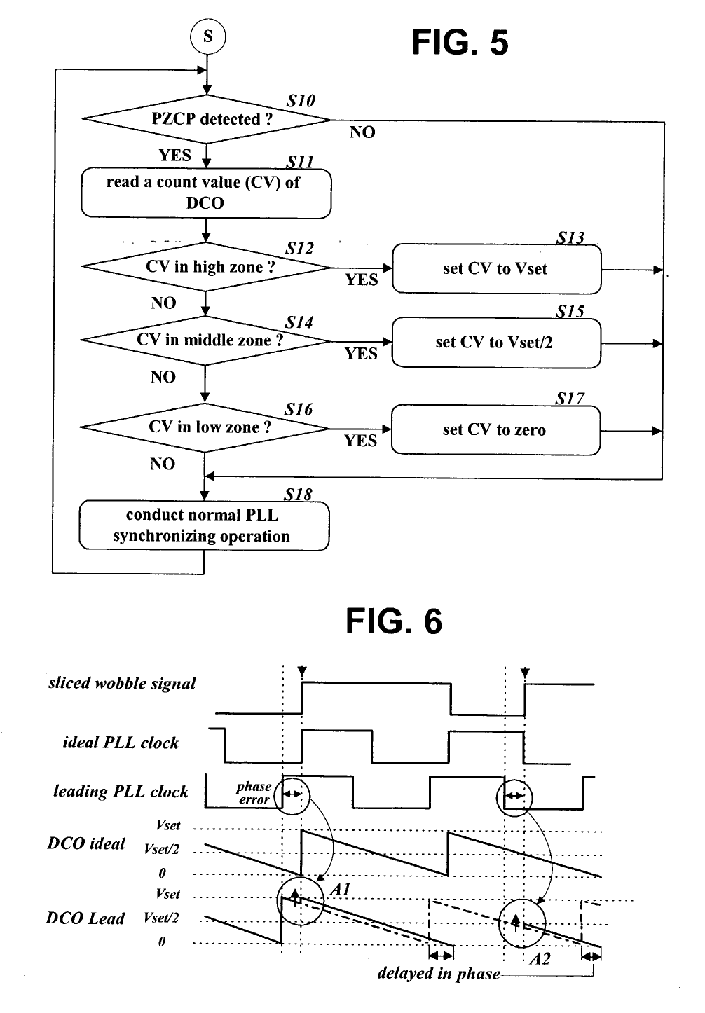

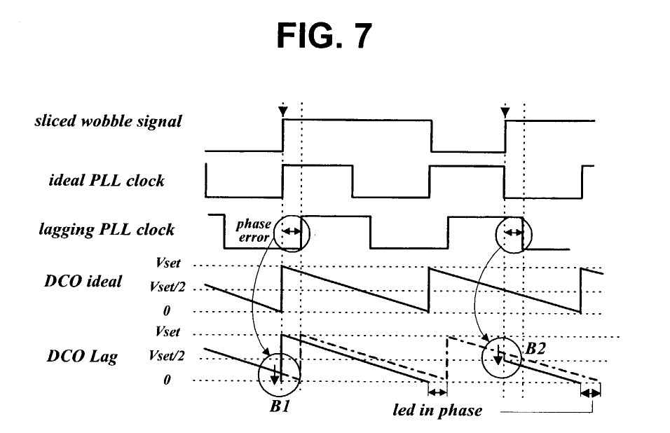

While the phase synchronization is conducted as aforementioned, the bidirectional phase-gap compensator (BPC) 20 compensates a phase-gap between the PLL clock and the wobble signal as illustrated in FIG. 6 or 7 based on a gap compensating algorithm depicted in FIG. 5.

FIG. 6 illustrates a phase-gap compensation for a lead case where the PLL clock leads the wobble signal in phase, and FIG. 7 illustrates for a lag case where the PLL clock lags in phase. In both cases of FIGS. 6 and 7, a phase gap is compensated based on the algorithm depicted in FIG. 5, which is explained in detail

The BPC 20 slices up or down the digitized wobble signal 201 to produce the square-wave wobble signal 202, and checks whether the square-wave wobble signal 202 makes a transition from negative to positive (S10). When the transition occurs, the BPC 20 reads a current value being counted by the DCO 14 (S11) and resets the count value to other one based on which count zone the read value belongs to.

If the read value belongs to a high zone (S12), the count value is set to an initial value corresponding to the Vset (S13). If a middle zone (S14), it is set to a half of the initial value (S15), and if a low zone (S16), it is set to 0 (S17).

Preferably, the high zone has a range from a maximum count value (Cmax) corresponding to the applied Vset to 90% thereof, namely 0.9 Cmax, the middle zone from 0.55 Cmax to 0.45 Cmax, and the low zone from 0.1 Cmax to zero.

For example, if it takes 100 clocks to count down from an applied Vset to zero, the high zone is from 90 to 100, the middle zone from 45 to 55, and the low zone 0 to 10.

FIG. 6 illustrates a phase-gap compensation achieved through the above count-value mapping operation conducted at a PZCP (Positive Zero Crossing Point). The circle A1 on FIG. 6 shows that a count value of the DCO 14 within the high zone is set to an initial value, namely, Vset to delay the PLL clock having led the wobble signal immediately, and the circle A2 on FIG. 6 shows that a count value within the middle zone is set to Vset/2 to delay the PLL clock immediately, which results in reduction in phase gap.

FIG. 7 illustrates a phase-gap compensation for a lag case. The circle B1 on FIG. 7 shows that a count value of the DCO 14 within the low zone is set to zero to immediately advance phase of the PLL clock having lagged the wobble signal, and the circle B2 on FIG. 7 shows a count value within the middle zone is set to Vset/2 to reduce a phase gap between the lagged PLL clock and the wobble signal.

If a phase gap is so large that the read count value belongs to none of the three zones (S18), such a phase gap is not compensated by the BPC 20. Instead, it will be eliminated later by the phase difference detector 12 and the loop filter 13 that adjust the Vset of the DCO 14 in proportion to the phase gap.

While the BPC 20 conducts the above-explained phase-gap compensation at every PZCP, the phase difference detector 12, the loop filter 13, and the DCO 14, which are included in the wobble PLL 200 of FIG. 4, detect a phase difference at every NZCP and make the PLL clock in phase with the wobble signal based on the detected phase difference.

However, the three elements, the phase difference detector 12, the loop filter 13, and the DCO 14 can conduct phase synchronization at PZCP not at NZCP. If a phase difference detection and a phase adjustment are all conducted at PZCP, deterioration in jitter characteristic of the PLL clock can be prevented. This is because a PZCP is less affected by a characteristic of a band-pass filter, a slice level, shapes of a wobble signal, etc. than a NZCP, thus, phase difference detection and phase adjustment can be conducted at more uniform interval.

The above-explained phase error compensating apparatus and method compensate a phase gap between a PLL clock and an input wobble signal the moment it is detected, thereby making the PLL clock in phase with the wobble signal faster.

Furthermore, phase synchronization at every PZCP would make a variance of phase adjustment intervals much smaller, thereby reducing timing jitter of the PLL clock remarkably.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus of locking a clock in phase with an input wobble signal detected from a recording medium, comprising:
a clock generator generating the clock through a repetitive free-running count operation of an applied control signal;
a phase error detector detecting a phase error between the clock and the wobble signal;
a controller adjusting the control signal based on the detected phase error; and
a phase gap compensator reading a current count value of said clock generator and setting the count value to one of predetermined values forcibly at a certain point of the wobble signal, said one being chosen based on the read count value.

2. The apparatus of claim 1, wherein said phase gap compensator has three predetermined zones, and sets the current count value of said clock generator to a maximum value to count if the read count value belongs to a first zone, to a half of the maximum value if belongs to a second zone, or to zero if belongs to a third zone.

3. The apparatus of claim 2, wherein, if the maximum value to count is represented as Cmax, the first zone is 0.9 Cmax to Cmax, the second zone 0.45 Cmax to 0.55 Cmax, and the third zone 0 to 0.1 Cmax.

4. The apparatus of claim 1, wherein said certain point of the wobble signal is a transition point from negative to positive level.

5. The apparatus of claim 1, wherein said phase error detector detects the phase error when the wobble signal makes transition from negative to positive level.

6. A method of compensating a phase gap between a clock and an input wobble signal detected from a recording medium, comprising the steps of:
(a) checking whether or not the wobble signal is at a certain signal state;
(b) reading a current count value of a clock generator when the wobble signal is at the certain signal state, the clock generator generating the clock through a repetitive free-running count operation of an applied control signal; and
(c) checking which zone the read count value belongs to, and setting the count value to one of predetermined values forcibly, said one being chosen based on the zone the read count value belongs to.

7. The method of claim 6, wherein said step (c) sets the current count value of said clock generator to a countable maximum value if the read count value belongs to a first zone among three predetermined zones, to a half of the countable maximum value if belongs to a second zone, or to zero if belongs to a third zone.

8. The method of claim 7, wherein, if the countable maximum value is represented as Cmax, the first zone is 0.9 Cmax to Cmax, the second zone 0.45 Cmax to 0.55 Cmax, and the third zone 0 to 0.1 Cmax.

9. The method of claim 6, wherein said certain signal state represents a point at which the wobble signal makes a transition from negative to positive level.
